(19) United States
(12) Patent Application Publication
(10) Pub. No.: US 2001/0014692 A1
(43) Pub. Date: Aug. 16, 2001

(54) Method for protecting plants

(76) Inventors: Philippe Chemla, Durham, NC (US); Michael Oostendorp, Rheinfelden (DE)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 09/755,936

(22) Filed: Jan. 5, 2001

(30) Foreign Application Priority Data
Jul. 8, 1998 (GB) 9814783.8

(51) Int. Cl. A01N 43/82

(52) U.S. Cl. 514/361

(57) ABSTRACT

A method of protecting and immunizing plants against attack by insects, acarina, nematodes and viruses, and for improving the qualities of the plants, which method comprises applying to the plants, to parts of the plants and/or to the locus of the plants an effective amount of a compound of formula I

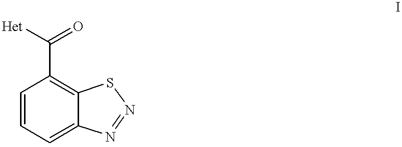

in which

Het is an optionally substituted 5- or 6-membered aromatic ring having 1-3 hetero atoms N, O and/or S; in particular selected from the group

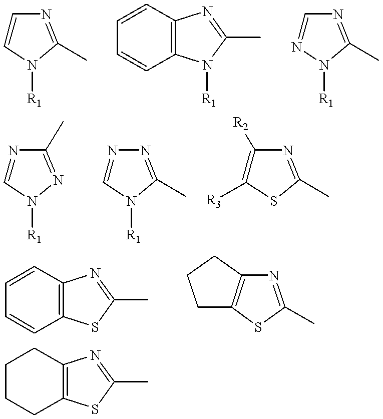

wherein

R₁ is hydrogen, optionally substituted C₁-C₆alkyl, optionally substituted C₂-C₆alkenyl or optionally substituted phenyl and R₂ and R₃ independently of each other are hydrogen or optionally substitued C₁-C₆alkyl, and acid addition salts and metal salt complexes thereof.

The present invention relates to a method of protecting and immunizing plants against attack by insects, acarina, nematodes and viruses, and for improving the qualities of the plants, which method comprises applying to the plants, to parts of the plants and/or to the locus of the plants an effective amount of a compound of formula I

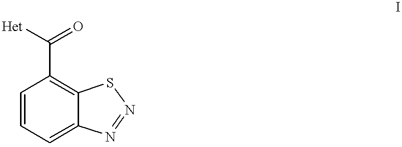

in which

Het is an optionally substituted 5- or 6-membered aromatic ring having 1-3 hetero atoms N, O and/or S; in particular selected from the group

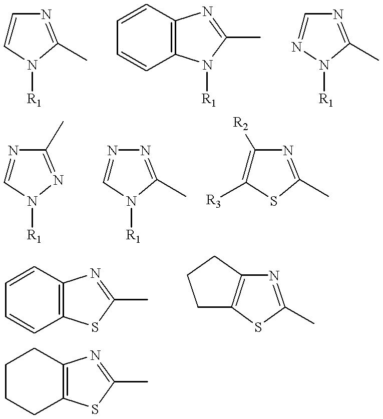

wherein

R₁ is hydrogen, optionally substituted C₁-C₆alkyl, optionally substituted C₂-C₆alkenyl or optionally substituted phenyl and

R₂ and R₃ independently of each other are hydrogen or optionally substitued C₁-C₆alkyl, and acid addition salts and metal salt complexes thereof.

It is known from EP-A-816,363 that compounds of formula I are active as microbicides and may be used in agriculture and horticulture for directly combating undesired phytopathogenic fungi and bacteria or for immunizing plants against attack of phytopathogenic fungi and bacteria by inducing “Systemic Activated Resistance” (SAR) in the plants.

Surprisingly it has now been found that compounds of formula I can be used for protecting and immunizing plants against attack by insects, acarina, nematodes and viruses, and for improving the qualities of the plants.

In the above formula alkyl designates straight chain and branched alkyl groups, such as methyl, ethyl, n-propyl, i-propyl, n-butyl, s-butyl, i-butyl, t-butyl, n-pentyl, i-pentyl, s-pentyl, neo-pentyl, and the various isomers of hexyl.

Alkenyl is straight-chain or branched alkenyl such as allyl, methallyl, 1-methylvinyl or but-2-en-1-yl. Preferred alkenyl radicals contain 3 to 4 carbon atoms in the chain.

Substituents at alkyl, alkenyl and phenyl include halogen, such as fluoro, chloro, bromo and iodo; cyano; alkoxy, such as methoxy, ethoxy, n-propoxy, i-propoxy, and the various isomers of butoxy; alkylthio, such as methylthio and ethylthio; alkoxycarbonyl, such as methoxycarbonyl and ethoxycarbonyl; and phenyl.

Preferred compounds of formula exhibiting the new utilities according to the invention are those wherein

R₁ is hydrogen, C₁-C₄alkyl, C₁-C₄haloalkyl, phenyl-C₁-C₄alkyl, cyano- C₁-C₄alkyl, C₁-C₂alkoxy-C₁₋₄alkyl, C₁-C₂alkythio- C₁-C₄alkyl, C₁-C₂alkoxycarbonyl- C₁-C₄alkyl, C₂-C₄alkenyl, phenyl, halogen substituted phenyl or C₁-C₄alkyl substituted phenyl and R₂ and R₃ independently of each other are hydrogen or C₁-C₄alkyl.

Particularly preferred are those, wherein

R₁ is hydrogen, methyl, ethyl, propyl, isopropyl, butyl, cyanomethyl, 2-cyanoethyl, 1-cyanoethyl, 3-cyano-propyl, methoxymethyl, ethoxymethyl, methylthiomethyl, methoxycarbonyl-ethyl, ethoxycarbonyl-methyl, ethoxycarbonyl-ethyl, fluoromethyl, difluoromethyl, trifluoromethyl, chloromethyl, benzyl, phenyl, chlorophenyl, methylphenyl, vinyl, allyl or but-3-en-1-yl, and

R₂ and R₃ independently of each other are hydrogen, methyl, ethyl, propyl or isopropyl.

Especially preferred are the specific compounds as disclosed in EP-A-816,363.

Suitable acid addition salts and metal salts complexes thereof are also described in this reference.

The compounds of formula I can be used in the agricultural sector and related fields preventively and/or curatively as active ingredients. In general, plants can be protected both by direct action on the pests or by activation and stimulation of the plant's own defense system (immunization). The latter mode of action has also become known by the name “Systemic Activated Disease Resistance” (“SAR”). Accordingly, using the compounds of the invention, plants can be kept healthy and strengthened by their own resources.

The compounds of formula I are well tolerated by plants and are environmentally friendly. They can be used to inhibit or destroy the pests which occur on plants or on parts of plants (the fruit, blossom, leaves, stems, tubers or roots) of different crops of useful plants, while at the same time parts of plants that grow later are also protected.

The compounds I can also be used as dressings in the treatment of seed (fruit, tubers, grains) and plant cuttings to provide protection against insects, acarina, nematodes and viruses.

A) Insects include, for example, Lepidoptera (e.g. Cydia, Heliotis, Lobesia, Pyralididae, Geometridae, Noctuidae); Thysanoptera (e.g. Frankliniella, Thrips palmi); Heteroptera (e.g.Capsidae, Pentatomidae); Homoptera (e.g. Bemisia tabaci, Nilaparvata, Delphacidae, Jassidae, Psyllina, Aphidina, Aphis, Coccina); Diptera (e.g. Musca, Trypetidae, Cecidomyiidae); Coleoptera (e.g. Chrysomelidae, Curculionidae).

B) Acarina include, for example, Tetranychidae, Tarsonemidae, Eriophydae, Phyllocoptidae.

C) Phytopathogenic Nematodes include, for example, nematodes of the genera Heterodera and Globodera (cystogenic nematodes), Meloidogyne (root-knot nematodes), Radopholus, Pratylenchus, Tylenchulus, Longidorus, Trichodorus, Xiphinema, Ditylenchus (stem parasites), Aphelenchoides (leaf nematodes), and Anguina (blossom nematodes); particularly harmful nematode species of the genus Meloidogyne, for example Meloidogyne incognita, and of the genus Heterodera, for example Heterodera glycines (soybean cyst nematode).

D) Phytopathogenic viruses include, for example, Rod-shaped Viruses (e.g. TMV, TRV, Carlavirus, BYV, PVX, PVY), Sphaeric Viruses (e.g. Tymovirus, Nepovirus, TRV, TNV, CMV, Comovirus, Tombusvirus), Alfalfa Mosaic Virus, Diplornaviruses (e.g. Tomato spotted wilt virus, Rhabdovirus), Cauliflower Mosaic Virus.

Quality of plants means, for example, shape and size, flavor and taste, colour, imperishable nature, content of useful ingredients, as nutritive substance, vitamins etc.

Target crops to be activated within the scope of the present invention comprise e.g. the following species of plants: cereals (wheat, barley, rye, oats, rice, maize, sorghum and related species); beet (sugar beet and fodder beet); pomes, stone fruit and soft fruit (apples, pears, plums, peaches, almonds, cherries, mirabella, mangos strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (marrows, cucumber, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocados, cinnamon, camphor); and plants such as tobacco, nuts, coffee, aubergines, sugar cane, tea, pepper, vines, hops, bananas and natural rubber plants, as well as ornamentals(flowers, shrubs, broad-leaved trees and evergreens, such as conifers). This list does not represent any limitation.

The compounds I are generally used in the form of compositions and can be applied to the crop area or plant to be treated, simultaneously or in succession, with further compounds. These further compounds can be, for example, fertilizers or micronutrient donors or other preparations that influence plant growth. They can also be selective herbicides as well as insecticides, fungicides, bactericides, nematicides, molluscicides, plant activators or mixtures of several of these preparations, if desired together with further carriers, surfactants or other application-promoting adjuvants customarily employed in formulation technology. A preferred method of applying a compound of formula 1, or an agrochemical composition comprising at least one of those compounds, is application to the leaves (foliar application). The frequency and rate of application depend upon the risk of infestation by the corresponding pathogen. The compounds I can, however, also penetrate the plant through the roots via the soil (systemic action) if the locus of the plant is impregnated with a liquid formulation or if the substances are introduced in solid form into the soil, e.g. in the form of granules (soil application). In paddy rice crops, such granules can be applied in metered amounts to the flooded rice field or to the seedling box before transplanting. In order to treat seed, the compounds I can, however, also be applied to the seeds (coating), either by impregnating the grains or tubers with a liquid formulation of the active ingredient, or by coating them with a solid formulation.

The compounds I are used in unmodified form or, preferably, together with the adjuvants conventionally employed in formulation technology. For that purpose they are advantageously formulated in known manner e.g. into emulsifiable concentrates, coatable pastes, directly sprayable or dilutable solutions, dilute emulsions, wettable powders, soluble powders, dusts or granules, for example by encapsulation in e.g. polymer substances. As with the nature of the compositions, the methods of application, such as spraying, atomizing, dusting, scattering, coating or pouring, are chosen in accordance with the intended objectives and the prevailing circumstances.

Advantageous rates of application of the active ingredient mixture are normally from 0.01 to 10 kg of active ingredient (a.i.) per hectare, preferably from 30 g to 1000 g a.i./ha, especially from 100 g to 700 g a.i./ha. In the case of the treatment of seed, the rates of application are from 0.5 g to 1000 g, preferably from 5 g to 100 g, a.i. per 100 kg of seed.

The agrochemical compositions generally comprise 0.1 to 99% by weight, preferably 0.1 to 95% by weight, of a compound of formula 1, 99.9 to 1% by weight, preferably 99.8 to 5% by weight, of a solid or liquid adjuvant and 0 to 25% by weight, preferably 0.1 to 25% by weight, of a surfactant. The compositions may also comprise further auxiliaries, such as stabilizers, antifoams, viscosity regulators, binders or tackifiers, as well as fertilizers or other active ingredients for obtaining special effects. Manufacturing of the formulations is a routine matter in the art of pesticides and largely depends on the desired mode of application and target plant.

### EXAMPLES

Preparation Examples

Working procedures for preparing the compounds of formula I and examples of such compounds are described in EP-A-816,363.

Formulation Examples

Working procedures for preparing formulations of the compounds of formula I such as emulsifiable concentrates, solutions, granules, dusts and wettable powders are described for example in EP-A-816,363 and WO 97/33890.

### Biological Examples

A. Action Against Insects

### Example A.1

Action Against Aphis craccivora

Pea seedlings are treated with a spray mixture comprising 100 ppm of active ingredient and 3 days later infected with Aphis craccivora and incubated at 20-22° C. 6 and 12 days later, the percentage reduction in population (% activity) is determined. Compounds of formula I exhibit good activity.

### Example A.2

Action Against Liriomvza sp.

After a cultivation period of 3 weeks, tomato plants are sprayed with a spray mixture prepared from a wettable powder formulation of the test compound (0.06% active ingredient). After 96 hours, the treated plants transferred into large buckets sealed with cellophane. Adult Liriomyca are introduced into each bucket and allowed to feed and oviposit for 24 h and then removed. After 13-17 days the experiments are evaluated by counting number of mines, oviposition and feeding punctures.

Compounds of formula I exhibit good activity and reduce insect attack by 20 to 60%.

### Example A.3

Action Against Bemisia argentifolii

After a cultivation period of 3 weeks, tomato plants are sprayed with a spray mixture prepared from a wettable powder formulation of the test compound (0.06% active ingredient). After 96 hours, the treated plants covered under closed cylinders and Bemisia is introduced. Eggs and nymphs are counted on the terminal trifoliate after 5 to 10 days using a stereomicroscope. In addition plant damage is estimated visually.

Compounds of formula I exhibit good activity and reduce insect attack by 20 to 60%.

B. Action Against Acarina

### B.1

Action Against Tetranychus urticae

Young bean plants are sprayed with an aqueous emulsion spray mixture which comprises 400 ppm of the active ingredient; one day later the plans are populated with a mixed population of Tetranychus urticae and subsequently incubated for 6 days at 25° C. The percentage reduction in population (% action) is determined by comparing the number of dead eggs, larvae and adults on the treated with those on the untreated plants. Compounds of formula I exhibit good activity.

C. Action Against Nematodes

### Example C.1

Action Against a Mixed Population of Meloidogyne javanica and Meloidogyne arenaria on Grapevines.

Grapevines (Cabernet Sauvignon) are treated with a compound of formula I (250 mg per liter of spay mixture) one week before inoculation, at inoculation and/or one week after inoculation with a mixed population of Meloidogyne javanica and Meloidogyne arenaria. After 4 weeks, the total number of eggs produced is evaluated.

The treated plants exhibit only 10-40% eggs related to non treated plants, corresponding to an efficacy of 60-90% of the method. Compounds of formula I exhibit good activity.

### Example C.2

Action Against Meloidogyne incognita on Tomato Plants

Eggs of Meloidogyne incognita are mixed into sand. This mixture is then put into 200 ml clay pots (5000 eggs per pot). On the same day a three-week-old tomato plant is planted in each pot and the formulated test compound is introduced into the pots by drench application (0.0006% of active ingredient, based on the volume of the soil). The potted plants are then placed in a greenhouse at a temperature of 26±1° C. and a relative humidity of 60%. After 4 weeks, evaluation is made by examining the plants for root-knot formation in accordance with the Root-Knot Index. Compounds of formula I exhibit good activity.

### Example C.3

Action against Heterodera glycines on Soybeans

Sandy soil is infested with eggs of the soybean cyst nematode H. glycines, approximately 6000 eggs per pot. The test compounds are then mixed in at the appropriate concentrations. The treated and infested soil is then put into 10 pots (180ccm) and three soybeans (cv. Maple Arrow) are sown in each pot. Each treatment is repeated three times. The pots are incubated in a greenhouse at about 27° C. for four to five weeks. The plants are then carefully removed from the pots, the roots are washed, and the number of cysts is determined.

### Example C.4

Direct effect of compounds of formula I onto nematodes Eggs and juvenile root-knot nematodes are placed into an aqueous solution of a compound of formula 1. No effect is observed on egg hatching and viability on those eggs and juvenils on penetration of those nematodes into tomato roots and on the number of eggs produced by those nematodes on tomatoes.

D. Action against viruses

### Example D.1

Action Against Tobacco Mosaic Virus on Tobacco

8 week old tobacco plants are sprayed or injected with a solution comprising 200 ppm of active ingredient. After 4 days, the plants are inoculated mechanically with a suspension of tobacco mosaic virus (0.5 l μl/ml+carborundum) and incubated at a temperature of 20-22° C. 7 days after the inoculation, the protective effect is assessed on the basis of the number and size of the local lesions. Compounds of formula I exhibit good immunizing action.

### Example D.2.

Action Against Tobacco Necrosis Virus on Cucumber

3 week old cucumber plants are sprayed with a solution comprising 200 ppm of active ingredient. After 4 days, the plants are inoculated mechanically with a suspension of tobacco necrosis virus (pH=7.0) and incubated at a temperature of 20-22▪C.7 days after inoculation, the protective effect is assessed on the basis of the number and size of lesions. Compounds of formula I exhibit good immunizing action.

1. The use of a compound of formula I 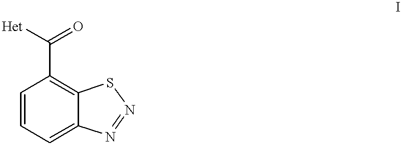
in which
Het is an optionally substituted 5- or 6-membered aromatic ring having 1-3 hetero atoms N, O and/or S; in particular selected from the group 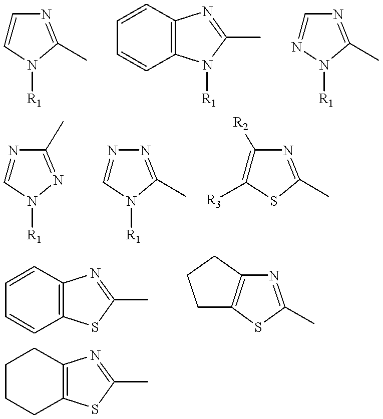
wherein
R₁ is hydrogen, optionally substituted C₁-C₆alkyl, optionally substituted C₂-C₆alkenyl or optionally substituted phenyl and
R₂ and R₃ independently of each other are hydrogen or optionally substitued C₁-C₆alkyl, and acid addition salts and metal salt complexes thereof; for protecting and immunizing plants against attack by insects, acarina, nematodes and viruses, and for improving the qualities of the plants.

2. The use according to claim 1 wherein plants are protected and immunized against attack by insects.

3. The use according to claim 1 wherein plants are protected and immunized against attack by acarina.

4. The use according to claim 1 wherein plants are protected and immunized against attack by nematodes.

5. The use according to claim 1 wherein plants are protected and immunized against attack by viruses.
